(19) United States
(12) Patent Application Publication
(10) Pub. No.: US 2026/0340710 A1
(43) Pub. Date: Oct. 29, 2026

(54) PHOTOGRAPHER MOBILE APPLICATION DEVICE

(71) Applicant: Anthony Burton, Durham, NC (US)

(72) Inventor: Anthony Burton, Durham, NC (US)

(21) Appl. No.: 19/735,902

(22) Filed: Jul. 9, 2026

Related U.S. Application Data
(63) Continuation-in-part of application No. 18/402,938, filed on Jan. 3, 2024.
(60) Provisional application No. 63/436,940, filed on Jan. 4, 2023.

(51) Int. Cl. G06Q 30/0601; G06Q 30/0282

(52) U.S. Cl. CPC G06Q 30/0639; G06Q 30/0282

(57) ABSTRACT

A photographer mobile application device is disclosed, that is a unique software application accessible on a smartphone, tablet, laptop, or a desktop computer. The application allows users to book a photographer for a short period of time. Further, the application finds the photographer based on the GPS location of the user. The application comprises a plurality of features, such as, but not limited to, a photographer portal, a calendar, an accept request feature, a payment information feature, a user portal, a GPS, a photographer identifier, a photographer profile, an appointment booking feature, a paying/tipping feature, and a review feature. In one embodiment, the application comprises a mandatory tip feature.

### CROSS-REFERENCE TO RELATED APPLICATION

The present application is a continuation-in-part patent application of, and claims priority to and the benefit of, U.S. patent application Ser. No. 18/402,938, which was filed on Jan. 3, 2024, and claims priority to and the benefit of U.S. Provisional Application No. 63/436,940, which was filed on Jan. 4, 2023, both of which are incorporated herein by reference in their entirety.

### FIELD OF THE INVENTION

The present invention relates generally to the field of photographer mobile application devices. More specifically, the present invention relates to a mobile application that allows a user to quickly obtain the services of another individual to take at least one photo. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in photographer mobile application devices. Generally, many individuals wish to take pictures while in public at various locations. However, in order to ensure all members of a group are included in said pictures, a group must find a third party to take a photo. In these scenarios, the third party is typically a nearby individual who may be walking past the group. Said individual may lack the ability to take the desired level of photo for a group, which is undesirable.

Further, having to set up a user's camera or mobile device to take a photo of all members of your group can be complicated and not possible based on the setting or other circumstances. Additionally, having to use the timer on your device to capture the photo can be problematic, leading to blurry photos or photos where a group member is inadvertently cropped out. Accordingly, a better and more convenient way of taking group photos is needed.

Accordingly, there is a demand for an improved photographer mobile application device that allows a user to obtain the services of a photographer for a short period of time. More particularly, there is a demand for a photographer mobile application device that allows a user to obtain photographer services via appointment and/or via geolocation.

Therefore, there exists a long-felt need in the art for a photographer mobile application device that allows a user to quickly obtain the services of another individual to take at least one photo. There is also a long-felt need in the art for a photographer mobile application device that allows a user to obtain the services of another individual to take photos for a short period of time. Further, there is a long-felt need in the art for a photographer mobile application device that allows a user to obtain the services of another individual to take photos for a short period of time via appointment and/or via geolocation. Moreover, there is a long-felt need in the art for a device that books a photographer based on the GPS location of the user. Further, there is a long-felt need in the art for a photographer mobile application device that comprises a plurality of features. Finally, there is a long-felt need in the art for a photographer mobile application device that comprises a payment information feature.

The subject matter disclosed and claimed herein, in one embodiment thereof, comprises a photographer mobile application device. The device is a unique software application accessible on a smartphone, tablet, laptop, or desktop computer. The application allows users to book a photographer for a short period of time. Further, the application finds the photographer based on the GPS location of the user. The application comprises a plurality of features, such as, but not limited to, a photographer portal, a calendar, an accept request feature, a payment information feature, a user portal, a GPS, a photographer identifier, a photographer profile, an appointment booking feature, a paying/tipping feature, and a review feature. In one embodiment, the application comprises a mandatory tip feature.

In this manner, the photographer mobile application device of the present invention accomplishes all of the foregoing objectives and provides users with a device that quickly obtains a photographer based on the location of a user. The device is a software application that utilizes the GPS location of a user to identify a nearby photographer. The device can comprise a plurality of features.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a photographer mobile application device. The device is a unique software application accessible on a smartphone, tablet, laptop, or a desktop computer. The application allows users to book a photographer for a short period of time. Further, the application finds the photographer based on the GPS location of the user. The application comprises a plurality of features, such as, but not limited to, a photographer portal, a calendar, an accept request feature, a payment information feature, a user portal, a GPS, a photographer identifier, a photographer profile, an appointment booking feature, a paying/tipping feature, and a review feature. In one embodiment, the application comprises a mandatory tip feature.

In one embodiment, the photographer mobile application device utilizes a smartphone, a tablet, a laptop, a desktop computer, etc., or any other suitable electronic device that has the required operating and memory parameters to support the software application of the present invention.

In one embodiment, the photographer mobile application device comprises a GPS system to track a user's location in real-time and a mobile computing device (i.e., smartphone, computer, tablet, etc.) comprising a software application for identifying available photographers in real-time. The mobile or software application provides a secure website and/or smartphone app access by users and/or photographers for availability and location. In addition to these elements, the device of the present invention may also include a web server and a Cloud database of photographer identification and location data connectable to the mobile smartphone, portable tablet, or computer device.

In one embodiment of the invention, the user's and/or photographer's GPS location and identification from the GPS system and data management software is maintained on a Microsoft Cloud server in a typical fashion, or other cloud servers, such as the Adobe, Apple or Amazon cloud server, etc. A secure cloud server is used for the protection and security of photographer identification and location, and information data stored on the cloud server. Thus, user and/or photographer GPS location from the GPS system, as well as photographer identification and availability, is sent to the cloud server and collected. Conveniently, the data is stored and managed with a data management software or program to manage the collected photographer identification data, user and/or photographer GPS location data, and photographer availability.

Typically, a cellular wireless data network embedded in the computer, tablet, or smartphone, etc., transmits photographer identification data, availability information, and a user's and/or photographer's GPS coordinates to a user and/or a cloud server associated with the software application. Such photographer and/or user identification and location data can be processed by the photographer and/or user via a Cloud data management server. Generally, GPS is embedded in the computer or tablet, etc., as it is in a smartphone. On the smart device, a digital mapping service, such as Microsoft Bing mapping or other competitive mapping services overlays the user's and/or photographer's GPS locations on the navigation mapping for visual tracking in real-time if needed. Thus, at any given time and location, a photographer can be identified and available.

The Global Positioning System (GPS) is a satellite-based navigation system made up of a network of 24 satellites placed into orbit by the U.S. Department of Defense. GPS was originally intended for military applications, but in the 1980s, the government made the system available for civilian use. The GPS system is embedded in many computers, tablets, smartphones, etc., and is used in navigation applications in these devices as well as vehicles and hunter or outdoor tracking devices.

Mobility is a key feature of the present invention. It permits flexibility. For example, if a user is attempting to take a group photo while traveling, the user can utilize the software application which determines the user's location and identifies any available photographers in the nearby vicinity. The software application would be accessed to identify available photographers and to book the photographer for a period of time to take at least one photograph. Further, in some embodiments, the photographer can also be paid and/or tipped via the software application.

The present invention offers a solution to identifying available photographers and focuses on utilizing the real-time location of a user to determine available photographers in the nearby vicinity. Further, a specific photographer can be located, as well, if a user previously knows their identification information. Specifically, GPS coordinates are used to locate the user via the GPS embedded in the smartphone, computer, or tablet, etc. The software application, which is accessed via a smartphone, tablet or computer, etc., then identifies and displays photographers' location in real-time, as well as their availability. Further, optional text message notifications, emails, and/or audio alerts can be utilized to notify users of photographers becoming available in their vicinity.

Generally, the software application also allows a user to book the desired photographer for a period of time, to take at least one photograph. Further, the software application also allows the user to pay and/or tip the photographer through the app. The app would be set up to accept credit card payments, as well as to be able to link to Venmo, PayPal, Cash App, etc., or any other suitable mobile payment services known in the art.

In one embodiment, the software application comprises a plurality of features or components, such as, but not limited to, a photographer portal, a calendar, an accept request feature, a payment information feature, a user portal, a GPS, a photographer identifier, a photographer profile, an appointment booking feature, a paying/tipping feature, a review feature, etc. For example, the software application can comprise a photographer portal and a user portal. The photographer portal allows a photographer to sign in and create an account and/or a photographer profile and photographer identifier. The photographer profile and identifier would list the photographer's name, contact information, background experience, primary location, and hours of availability, as well as any other information needed. The software application would keep the photographer's personal information secure, only allowing users to see specific items of information, such as location and availability. Then, if desired, the user would click on the request link or other means of requesting on the user interface, which would directly contact the photographer with the time and place requested. The user portal would allow a user to sign in and create an account to access the software application. Any suitable user interfaces can be utilized with the software application, as is known in the art.

Furthermore, the software application would have an appointment booking component that allows users to sign in and book photography appointments with available photographers. The appointment booking component would typically have a calendar to secure dates that identified photographers can show their availability on. Once a photographer is selected, a request can be sent to book the photographer for a period of time. An accept request component can then be sent to the user if the photographer accepts the request.

Additionally, the software application would have a payment information component. In this component, users and photographers can log their payment information and/or grant access or link to Venmo, PayPal, Cash App, etc., or any other suitable mobile payment services as is known in the art. The payment information component can also include a paying/tipping component, that allows a user to not only pay the photographer but also provides for a tip, if desired. In one embodiment, the software application can comprise a component that provides for mandatory tips that can be set at a predetermined percentage. Finally, the software application can also comprise a review component that allows users to leave reviews and comments for the photographers. Any other suitable components or features can be included with the software application as is known in the art, depending on the wants and/or needs of a user.

In yet another embodiment, the photographer mobile application device comprises a plurality of indicia.

In yet another embodiment, a method of locating a photographer based on a user's location in real-time using a software application is disclosed. The method includes the steps of providing a photographer mobile application device comprising a software application that identifies the location of a photographer based on the GPS location of a user in real-time. The method also comprises accessing the software application. Further, the method comprises tracking the user in real-time via GPS on the application. The method also comprises identifying a nearby photographer via the GPS location of the user on the application. Finally, the method comprises booking the photographer for a period of time.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the photographer mobile application device of the present invention showing a user attempting to take a group photo in accordance with the disclosed architecture;

FIG. 2 illustrates a perspective view of one embodiment of the photographer mobile application device of the present invention showing a user using the application to locate a photographer in accordance with the disclosed architecture;

FIG. 3 illustrates a perspective view of one embodiment of the photographer mobile application device of the present invention showing a smart device with the application in accordance with the disclosed architecture;

FIG. 4 illustrates a perspective view of one embodiment of the photographer mobile application device of the present invention showing a tablet with the application in accordance with the disclosed architecture;

FIG. 5 illustrates a perspective view of one embodiment of the photographer mobile application device of the present invention showing a laptop with the application in accordance with the disclosed architecture;

FIG. 6 illustrates a flowchart showing the method of locating a photographer based on a user's location in real-time using a software application in accordance with the disclosed architecture;

FIG. 7 is a schematic diagram illustrating one embodiment of the software application for locating a photographer of the present invention in accordance with the disclosed architecture;

FIG. 8 illustrates an exemplary user device that is used for installing the software application for locating a photographer of the present invention for communication with a server system in accordance with the disclosed architecture; and

FIG. 9 is a schematic diagram illustrating one embodiment of the software application for locating a photographer of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a photographer mobile application device that allows a user to quickly obtain the services of another individual to take at least one photo. There is also a long-felt need in the art for a photographer mobile application device that allows a user to obtain the services of another individual to take photos for a short period of time. Further, there is a long-felt need in the art for a photographer mobile application device that allows a user to obtain the services of another individual to take photos for a short period of time via appointment and/or via geolocation. Moreover, there is a long-felt need in the art for a device that books a photographer based on the GPS location of the user. Further, there is a long-felt need in the art for a photographer mobile application device that comprises a plurality of features. Finally, there is a long-felt need in the art for a photographer mobile application device that comprises a payment information feature.

The present invention, in one exemplary embodiment, is a novel photographer mobile application device. The device is a unique software application accessible on a smartphone, tablet, laptop, or a desktop computer. The application allows users to book a photographer for a short period of time. Further, the application finds the photographer based on the GPS location of the user. The application comprises a plurality of features, such as, but not limited to, a photographer portal, a calendar, an accept request feature, a payment information feature, a user portal, a GPS, a photographer identifier, a photographer profile, an appointment booking feature, a paying/tipping feature, and a review feature. In one embodiment, the application comprises a mandatory tip feature. The present invention also includes a novel method of locating a photographer based on a user's location in real-time using a software application. The method includes the steps of providing a photographer mobile application device comprising a software application that identifies the location of a photographer based on the GPS location of a user in real-time. The method also comprises accessing the software application. Further, the method comprises tracking the user in real-time via GPS on the application. The method also comprises identifying a nearby photographer via the GPS location of the user on the application. Finally, the method comprises booking the photographer for a period of time.

The artificial intelligence software (AI) will be built into the application. The AI software will make numerous features available, such as photo editing, enhancement, etc. Additionally, data analytics will be conducted to determine users' preferences. Photographers will receive suggestions and/or recommendations on how to improve their photography skills and improve their quality of image.

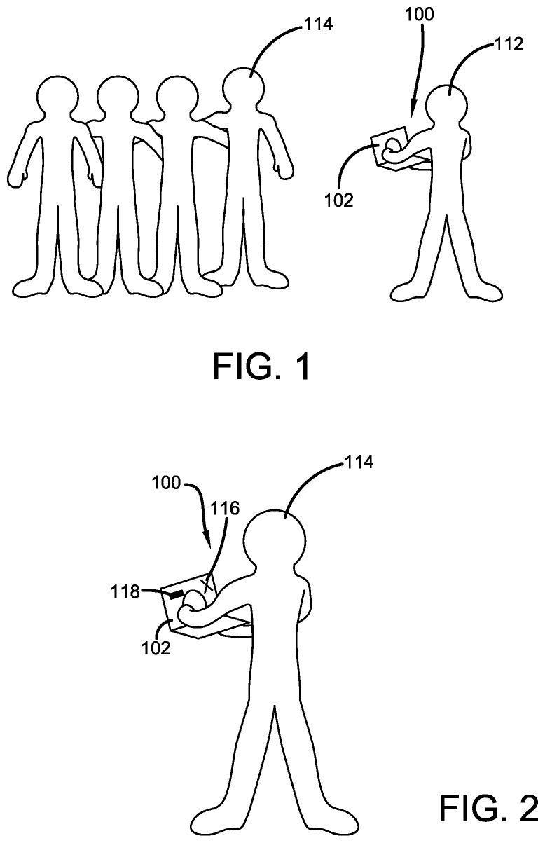

Referring initially to the drawings, FIG. 1 illustrates a perspective view of one embodiment of the photographer mobile application device 100 of the present invention. In the present embodiment, the photographer mobile application device 100 is a software application that allows users 114 to locate and book a nearby photographer 112 in real-time. Specifically, the photographer mobile application device 100 is a unique software application accessible on a smartphone, tablet, laptop, or a desktop computer (i.e., user device 102). A user's location is determined via GPS and nearby photographers 112 are identified in real-time. Once a photographer 112 is identified, a user 114 can book the photographer 112 for a period of time via the software application. Thus, photographers 112 can be accessed quickly and booked for a short period of time to take photos of a group of people, as needed.

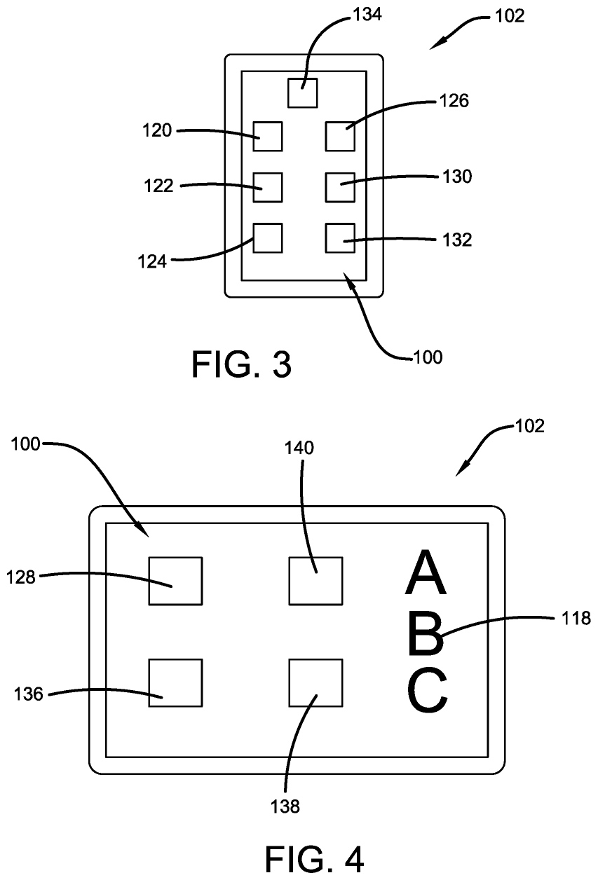

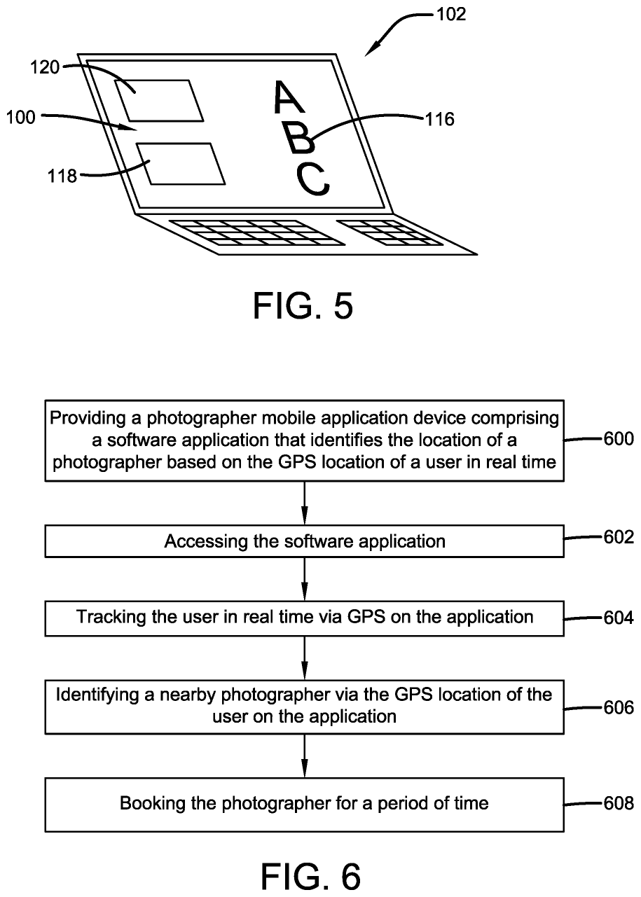

As shown in FIGS. 2-5, the photographer mobile application device 100 utilizes a smartphone, a tablet, a laptop or a desktop computer, etc. (i.e., user device 102), or any other suitable electronic device that has the required operating and memory parameters to support the software application of the present invention.

Generally, the photographer mobile application device 100 is a software application that comprises a GPS system to determine a user's location in real-time and a mobile computing device 102 (i.e., smartphone, computer, tablet, etc.) for identifying available photographers 112 in real-time. The mobile or software application provides a secure website and/or smartphone app access by users 114 and/or photographers 112 for availability and location. In addition to these elements, the device 100 of the present invention may also include a web server/application server 108 and Cloud database 110 of photographer identification and location data connectable to the mobile smartphone or portable tablet or computer device 102.

In one embodiment of the invention, the user's and/or photographer's GPS location and identification from the GPS system and data management software is maintained on a Microsoft Cloud server in a typical fashion, or other cloud server, such as the Adobe, Apple or Amazon cloud server, etc. A secure cloud server is used for the protection and security of photographer identification and location, and information data stored on the cloud server. Thus, user and/or photographer GPS location from the GPS system, as well as photographer identification and availability, is sent to the cloud server and collected. Conveniently, the data is stored and managed with a data management software or program to manage the collected photographer identification data, user and/or photographer GPS location data, and photographer availability.

Typically, a cellular wireless data network 106 embedded in the computer, tablet or smartphone, etc., (i.e., user device 102), transmits both photographer identification data, availability information, and a user's and/or photographer's GPS coordinates to a user 114 and/or a cloud server associated with the software application. Such photographer and/or user identification and location data can be processed by the photographer 112 and/or user 114 via a Cloud data management server. Generally, GPS is embedded in the computer or tablet, etc., 102, as it is in a smartphone. On the smart device 102, a digital mapping service, such as Microsoft Bing mapping or other competitive mapping services overlays the user's and/or photographer's GPS locations on the navigation mapping for visual tracking in real-time if needed. Thus, at any given time and location, a photographer 112 can be identified and available.

The Global Positioning System (GPS) is a satellite-based navigation system made up of a network of 24 satellites placed into orbit by the U.S. Department of Defense. GPS was originally intended for military applications, but in the 1980s, the government made the system available for civilian use. The GPS system is embedded in many computers, tablets, smartphones, etc., 102, and is used in navigation applications in these devices 102 as well as vehicles and hunter or outdoor tracking devices.

Mobility is a key feature of the present invention. It permits flexibility. For example, if a user 114 is attempting to take a group photo while traveling, the user 114 can utilize the software application which determines the user's location and identifies any available photographers 112 in the nearby vicinity. The software application would be accessed to identify available photographers 112 and to book the photographer 112 for a period of time to take at least one photograph. Further, in some embodiments, the photographer 112 can also be paid and/or tipped via the software application 100.

Accordingly, the present invention offers a solution to identifying available photographers 112 and focuses on utilizing the real-time location of a user 114 to determine available photographers 112 in the nearby vicinity. Further, a specific photographer 112 can be located, as well, if a user 114 previously knows their identification information. Specifically, GPS coordinates are used to locate the user 114 via the GPS embedded in the smartphone, computer, or tablet, etc., (i.e., user device 102). The software application, which is accessed via a smartphone, tablet or computer, etc., 102, then identifies and displays photographers' location in real-time, as well as their availability. Further, optional text message notifications 118, emails, and/or audio alerts can be utilized to notify users 114 of photographers 112 becoming available in their vicinity.

Generally, the software application also allows a user 114 to book the desired photographer 112 for a period of time, to take at least one photograph. Further, the software application also allows the user 114 to pay and/or tip the photographer 112 through the app. The app would be set up to accept credit card payments, as well as to be able to link to Venmo, PayPal, Cash App, etc., or any other suitable mobile payment services known in the art.

Furthermore, the software application 100 comprises a plurality of features or components, such as, but not limited to, a photographer portal 120, a calendar 122, an accept request feature 124, a payment information feature 126, a user portal 128, a GPS 130, a photographer identifier 132, a photographer profile 134, an appointment booking feature 136, a paying/tipping feature 138, a review feature 140, etc. For example, the software application 100 can comprise a photographer portal 120 and a user portal 128. The photographer portal 120 allows a photographer 112 to sign in and create an account and/or a photographer profile 134 and photographer identifier 132. The photographer profile 134 and identifier 132 would list the photographer's name, contact information, background experience, primary location, and hours of availability, as well as any other information needed. The software application 100 would keep the photographer's personal information secure, only allowing users 114 to see specific items of information, such as location and availability. Then, if desired, the user 114 would click on the request link or other means of requesting on the user interface, which would directly contact the photographer 112 with the time and place requested. The user portal 128 would allow a user 114 to sign in and create an account to access the software application 100. Any suitable user interfaces can be utilized with the software application, as is known in the art.

Furthermore, the software application 100 would have an appointment booking component 136 that allows users 114 to sign in and book photography appointments with available photographers 112. The appointment booking component 136 would typically have a calendar 122 to secure dates that identified photographers 112 can show their availability on. The GPS 130 is then utilized to determine which available photographers 112 are located nearby the user 114. Typically, a list of photographers 112 is presented to the user 114 to choose from. Once a photographer 112 is selected, a request can be sent to book the photographer 112 for a period of time. An accept request component 124 can then be sent to the user 114, if the photographer 112 accepts the request.

Additionally, the software application 100 would have a payment information component 126. In this component, users 114 and photographers 112 can log their payment information and/or grant access or link to Venmo, PayPal, Cash App, etc., or any other suitable mobile payment services as is known in the art. The payment information component 126 can also include a paying/tipping component 138, that allows a user 114 to not only pay the photographer 112 but also provides for a tip if desired. In one embodiment, the software application 100 can comprise a component that provides for mandatory tips that can be set at a predetermined percentage. Finally, the software application 100 can also comprise a review component 140 that allows users 114 to leave reviews and comments for the photographers 112. Any other suitable components or features can be included with the software application 100 as is known in the art, depending on the wants and/or needs of a user 114.

In yet another embodiment, the photographer mobile application device 100 comprises a plurality of indicia 116. Specifically, the software application of the device 100 may include advertising, a trademark, or other letters, designs, or characters, printed, painted, stamped, or integrated into the software application, or any other indicia 116 as is known in the art. Specifically, any suitable indicia 116 as is known in the art can be included, such as, but not limited to, patterns, logos, emblems, images, symbols, designs, letters, words, characters, animals, advertisements, brands, etc., that may or may not be photographer, photo, or brand related.

FIG. 6 illustrates a flowchart of the method of locating a photographer based on a user's location in real-time using a software application. The method includes the steps of at 600, providing a photographer mobile application device comprising a software application that identifies the location of a photographer based on the GPS location of a user in real-time. The method also comprises at 602, accessing the software application. Further, the method comprises at 604, tracking the user in real-time via GPS on the application. The method also comprises at 606, identifying a nearby photographer via the GPS location of the user on the application. Finally, the method comprises at 608, booking the photographer for a period of time.

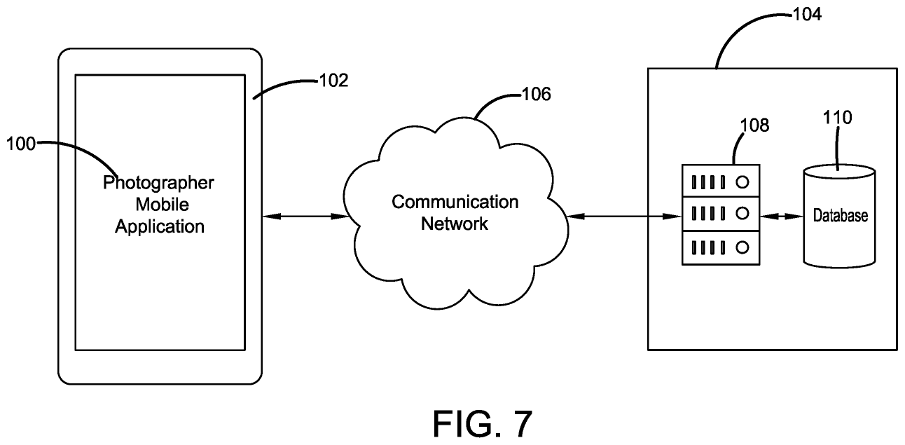

FIG. 7 is a schematic diagram illustrating one embodiment of the software application for identifying photographers 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch-sensitive device, a tablet, a computing device, a smart-phone, and/or a smartwatch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web framework, a . NET framework, a personal home page (PHP) framework, or any web application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users' account information from the application 100, as well as photographer identification and locations, and fees. In some embodiments, a set of centralized or distributed networks of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address), and the physical address may be a Media Access Control (MAC) address. The communication network 106 may be associated with an application layer for the implementation of communication protocols based on one or more communication requests from the user device 102 and the server system 104. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, or a combination of wireless and wired channels thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

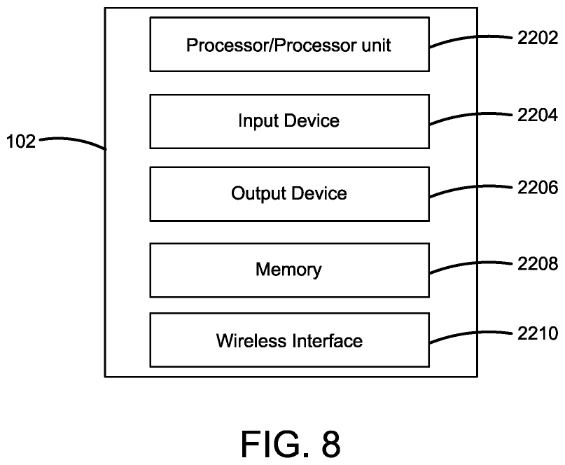

FIG. 8 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot, and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

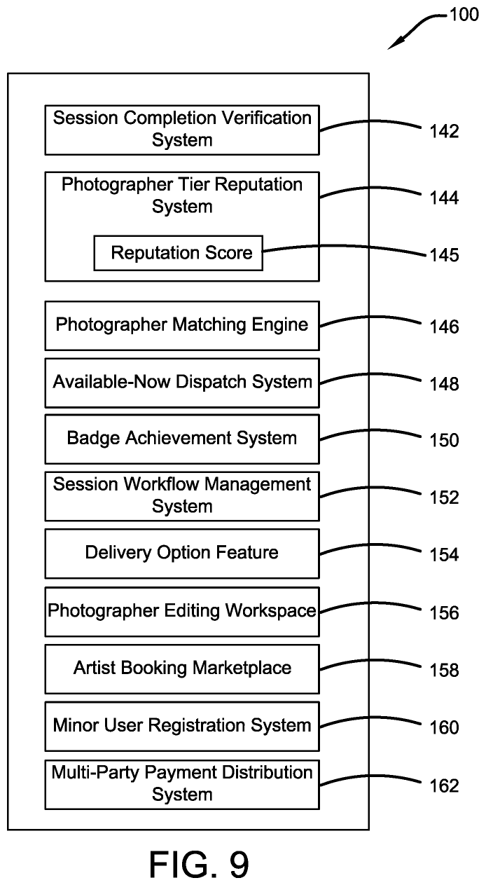

As seen in FIG. 9, the device 100 may have a plurality of other functions and features. In one embodiment, the software application 100 may further comprise a session completion verification system 142 configured to verify completion of a photography session before releasing payment. More specifically, following completion of an appointment, the photographer 112 may upload one or more photographs or other deliverables through the photographer portal 120. The user 114 may receive a notification to review the uploaded photographs or deliverables and confirm receipt through the user portal 128. Payment associated with the appointment may remain pending within the payment information feature 126 until the photographer 112 uploads the photographs or deliverables and the user 114 confirms receipt. Upon verification, the session completion verification system 142 may communicate with the paying/tipping feature 138 to release payment to the photographer 112.

In one embodiment, the software application 100 may further comprise a photographer tier and reputation engine 144 configured to automatically assign photographer tiers based on completed sessions, user ratings, response times, and performance metrics. The photographer tier and reputation engine 144 may generate a reputation score or ranking 145 and assign one or more photographer tiers, such as but not limited to Flash, Sharp, Prime, Op Master, Elite, or other ranking levels. The photographer tier and reputation engine 144 may update a photographer profile 134 with the assigned tier/score 145, wherein the assigned tier 145 may impact photographer visibility within the software application 100, available booking opportunities, and platform privileges.

In one embodiment, the software application 100 may further comprise an AI-based photographer matching engine 146 configured to recommend photographers 112 based on multiple selection factors instead of solely based on GPS proximity. The AI-based photographer matching engine 146 may communicate with the application server 108, the databases 110, the GPS 130, the photographer profile 134, and the review feature 140 to evaluate photographer specialty, user ratings, score 145, historical performance, availability, customer preferences, geographic location, or combinations thereof. Based on the evaluated information, the AI-based photographer matching engine 146 may generate one or more recommended photographers 112 for presentation to the user 114 through the software application 100.

In one embodiment, the software application 100 may further comprise an available-now dispatch feature 148 configured to allow a photographer 112 to activate an immediate availability mode through the photographer portal 120. Upon receiving a photography request, the available now dispatch feature 148 may automatically route the request to one or more photographers 112 currently designated as available. If a request is accepted, the appointment booking feature 136 may automatically assign and confirm the booking. If a request is declined or expires without acceptance, the available dispatch feature 148 may automatically reassign the request to another available photographer 112.

In one embodiment, the software application 100 may further comprise a badge and achievement system 150 configured to automatically award platform-generated badges and achievements to photographers 112. The badge and achievement system 150 may evaluate completed photography sessions, performance metrics, customer satisfaction, and milestone accomplishments to assign badges and achievements that may be displayed within the photographer profile 134.

In one embodiment, the software application 100 may further comprise an end-to-end session workflow management system 152 configured to manage the photography session process from booking through reputation score 145 updates. The end-to-end session workflow management system 152 may coordinate the appointment booking feature 136, the AI-based photographer matching engine 146, the session completion verification system 142, the payment information feature 126, the paying/tipping feature 138, and the photographer tier and reputation engine 144. The end-to-end session workflow management system 152 may manage photographer matching, session completion, photograph upload verification, user approval, payment release, and photographer reputation updates within a structured workflow associated with each photography appointment.

In one embodiment, the software application 100 may further comprise a delivery options feature 154 configured to allow photographers 112 to preset one or more available photo delivery methods through the photographer portal 120. Example delivery methods may include in-application delivery, secure gallery links, Google Drive, Dropbox, OneDrive, iCloud, electronic mail, or other electronic delivery options. During the appointment booking process, the available delivery methods may be presented to the user 114 for selection prior to confirming the appointment. The selected delivery method may be stored with the booking record and utilized by the session completion verification system 142 and the end-to-end session workflow management system 152 to facilitate photograph delivery, user confirmation, and payment release.

In one embodiment, the software application 100 may further comprise a photographer editing workspace 156 accessible through the photographer portal 120. The photographer editing workspace 156 may allow a photographer 112 to activate editing services, define available editing capabilities, establish editing pricing, and indicate available revision options. During the appointment booking process, the user 114 may be presented with the photographer's available editing services and may select a desired editing package. The selected editing option may be stored with the booking record as part of the photographer's service obligations. Following completion of the photography session, the photographer 112 may utilize the photographer editing workspace 156 to edit captured photographs and provide edited deliverables using the selected delivery method.

In one embodiment, the software application 100 may further comprise an artist booking marketplace 158 configured to allow artists, painters, sketch artists, muralists, and other creative professionals to create profiles, accept bookings, manage projects, deliver completed artwork, and receive payments through the software application 100. The AI-based photographer matching engine 146 may be configured to recommend creative professionals based on artistic specialty, portfolio quality, ratings, availability, customer preferences, and geographic location. The artist booking marketplace 158 may utilize the appointment booking feature 136, the payment information feature 126, the session completion verification system 142, and the end-to-end session workflow management system 152 to facilitate project management, artwork delivery, and payment processing.

In one embodiment, the software application 100 may further comprise a minor user registration and parental consent verification system 160 configured to permit registration of users between the ages of 16 and 17 following verified consent from a parent or legal guardian. The minor user registration and parental consent verification system 160 may perform age verification, request parent or legal guardian contact information, transmit a digital consent request, perform identity verification, store verified consent information within the databases 110, and monitor the account to maintain compliance. Upon successful verification of parental or legal guardian consent, the user account may be activated for use within the software application 100.

In one embodiment, the software application 100 may further comprise a multi-party payment distribution system 162 configured to automatically divide a client payment among multiple recipients based on predefined percentages or fixed amounts. The multi-party payment distribution system 162 may communicate with the payment information feature 126 and the paying/tipping feature 138 to process payments for multiple photographers 112, artists, assistants, event coordinators, platform fees, or other approved recipients. The multi-party payment distribution system 162 may store allocation rules, recipient payment information, transaction confirmations, and payment records within the databases 110 to support payment transparency.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “photographer mobile application device”, “photographer device”, “mobile application device”, and “device” are interchangeable and refer to the photographer mobile application device 100 of the present invention.

Notwithstanding the foregoing, the photographer mobile application device 100 of the present invention can be of any suitable size and configuration as is known in the art without affecting the overall concept of the invention, provided that it accomplishes the above-stated objectives. One of ordinary skill in the art will appreciate that the photographer mobile application device 100 as shown in FIGS. 1-8 is for illustrative purposes only, and that many other sizes and shapes of the photographer mobile application device 100 are well within the scope of the present disclosure. Although the dimensions of the photographer mobile application device 100 are important design parameters for user convenience, the photographer mobile application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A photographer mobile application device that allows users to identify available photographers in real-time, the photographer mobile application device comprising:
a software application comprising a session completion verification system and a photographer tier reputation engine; and
a GPS system that determines a user's location, wherein the software application identifies an available photographer based on the user's location.

2. The photographer mobile application device of claim 1, wherein the software application further comprises a reputation score.

3. The photographer mobile application device of claim 2, wherein users book available photographers for a period of time via the software application.

4. The photographer mobile application device of claim 1, wherein the software application further comprises a delivery option feature.

5. The photographer mobile application device of claim 1, wherein the software application further comprises a photographer editing workspace.

6. The photographer mobile application device of claim 1 further comprising a web server and a Cloud database of photographer identification, availability, and location data connectable to the smart device.

7. The photographer mobile application device of claim 1, wherein the software application further comprises an artist booking marketplace.

8. The photographer mobile application device of claim 1, wherein the software application further comprises a minor user registration system.

9. The photographer mobile application device of claim 1, wherein the software application further comprises a payment distribution system.

10. The photographer mobile application device of claim 1, wherein the software application further comprises a badge achievement system.

11. The photographer mobile application device of claim 1, wherein the software application further comprises a delivery option feature.

12. The photographer mobile application device of claim 1, wherein the software application further comprises a dispatch feature.

13. A photographer mobile application device that allows users to identify available photographers in real-time, the photographer mobile application device comprising:
a software application comprising a session completion verification system, a photograph matching engine, and a photographer tier reputation engine; and
a GPS system that determines a user's location, wherein the software application identifies an available photographer based on the user's location.

14. The photographer mobile application device of claim 13, wherein the software application further comprises an artist booking marketplace.

15. The photographer mobile application device of claim 13, wherein the software application further comprises a minor user registration system.

16. The photographer mobile application device of claim 13, wherein the software application further comprises a payment distribution system.

17. The photographer mobile application device of claim 13, wherein the software application further comprises a badge achievement system.

18. The photographer mobile application device of claim 13, wherein the software application further comprises a delivery option feature.

19. The photographer mobile application device of claim 13, wherein the software application further comprises a dispatch feature.

20. A photographer mobile application device that allows users to identify available photographers in real-time, the photographer mobile application device comprising:
a software application comprising a session completion verification system, a photograph matching engine, a session workflow management system, and a photographer tier reputation engine; and
a GPS system that determines a user's location, wherein the software application identifies an available photographer based on the user's location.
